(19) United States
(12) Patent Application Publication
(10) Pub. No.: US 2003/0214882 A1
(43) Pub. Date: Nov. 20, 2003

(54) Life time watch timepiece

(76) Inventor: James F. Kreidler, Palm Beach Gardens, FL (US)

Correspondence Address: James F. Kreidler, 538 Holly Drive #1, Palm Beach Gardens, FL, 33410, US

(21) Appl. No.: 10/150,423

(22) Filed: May 17, 2002

(51) Int. Cl. G04B 47/00

(52) U.S. Cl. 368/10

(57) ABSTRACT

An improved wristwatch timepiece with two internal electronic timers and two external push to start timer buttons. One timer will sound an internal audible alarm at the conclusion of ten minutes and one timer will sound an internal audible alarm at the conclusion of twenty minutes.

This watch timepiece will help rescuers keep track of “on scene” time when attempting to save lives in the field of emergency medical care of the sick and injured.

### FEDERALLY SPONSORED RESEARCH

Not Applicable

### SEQUENCE LISTING OR PROGRAM

Not Applicable

### BACKGROUND

1Field of Invention

This invention relates to a watch timepiece that will monitor “on scene” time for rescue workers.

2Description

Time will always be a critical factor in saving lives. From the moment rescuers are dispatched the race begins. Rescue workers work under a guideline called the “golden hour”.

Victims must arrive at the appropriate medical facility within one hour of the initial call for help.

Rescuers are allowed only 10 minutes of “on scene” time for trauma type calls such as vehicle accidents, shootings, stabbings etc.

The “on scene” time allowed for all other medical emergencies is 20 minutes.

One of the most difficult things for a rescuer to keep track of is time. On the scene of a serious incident their are many tasks to be completed.

A) This invention is a watch timepiece with two internal timers.

B) One push button will allow the rescuer to time “on scene” time of trauma calls.

C) One push button will time “on scene” time of all other medical type calls.

D) An audible alarm will sound at the prescribed time interval either ten, or twenty minutes.

### SUMMARY

This watch timepiece will at last enable rescuers to address the time management problem to better save lives in the field of medical emergencies.

I claim:

1. A watch timepiece that will help rescue workers measure their time on scene of medical emergencies.
I) A push button timer to measure the amount of time spent on trauma type emergencies.
II) A push button timer to measure the amount of time spent on all non trauma type emergencies.
III) An audible alarm that will sound off after ten minutes.
IV) An audible alarm that will sound off after twenty minutes.
Whereby the best possible outcome for injured persons will always be measured in minutes and seconds this watch timepiece will serve as a substantial tool in saving lives
